(19) United States
(12) Patent Application Publication
(10) Pub. No.: US 2024/0286594 A1
(43) Pub. Date: Aug. 29, 2024

(54) PARKING BRAKE DEVICE FOR VEHICLE

(71) Applicant: ADVICS CO., LTD., Kariya-shi, Aichi-ken (JP)

(72) Inventor: Masayuki NAITO, Kariya-shi, Aichi-ken (JP)

(73) Assignee: ADVICS CO., LTD., Kariya-shi, Aichi-ken (JP)

(21) Appl. No.: 18/573,559

(22) PCT Filed: Jun. 28, 2022
(86) PCT No.: PCT/JP2022/025705

§ 371 Date: Dec. 22, 2023

(30) Foreign Application Priority Data
Jul. 9, 2021 (JP) 2021-113922

(51) Int. Cl. B60T 13/68; B60T 13/66

(52) U.S. Cl. CPC B60T 13/686; B60T 13/662; B60Y 2400/81

(57) ABSTRACT

A parking brake device includes a fluid unit including: a fluid pump that suctions brake fluid from a master cylinder using a first electric motor; and a pressure regulating valve that increases pressure of the brake fluid discharged by the fluid pump and supplies the increased pressure to a wheel cylinder as a brake fluid pressure, the fluid unit causing the brake fluid pressure to press a friction member against a rotating member fixed to vehicle wheels to generate a braking force, an electrically-powered unit that uses a second electric motor and generates the braking force on a parking wheel on which a parking brake is applied among the vehicle wheels, and a controller that controls the fluid unit and the electrically-powered unit. When the parking brake is actuated, the controller increases only the brake fluid pressure corresponding to the parking wheel in the wheel cylinder.

### TECHNICAL FIELD

The present disclosure relates to a parking brake device for a vehicle.

### BACKGROUND ART

Patent Literature 1 describes “a method for actuating a braking mechanism of a motor vehicle having an electrically controllable service braking system (BBA) which generates braking force independently of the operation by the driver and an electrically controllable parking braking system (FBA) which generates braking force and maintains the force, in which the service braking system (BBA) additionally generates the required braking force if, in a given actuation condition, the parking braking system or the electromechanical drive unit has to maintain a braking force greater than the braking force which can be generated by the parking braking system, such that it is only necessary for the parking braking system or the electromechanical drive unit to cope with relatively small actuation conditions”.

Patent Literature 2 describes “an electric parking brake system 11 includes a drum-type brake device 6, an electric motor 52 that actuates the brake device 6 by pulling a brake cable 51, a VSC-ECU 4 that actuates the brake device 6 by pressurizing the fluid pressure, and an EPB-ECU 2 that controls the electric motor 52. The EPB-ECU 2 includes a parking ability determination unit 24 that determines whether or not braking force necessary for parking can be obtained by actuation of the brake device 6 by the electric motor 52, and a braking control unit 25 that causes the EPB-ECU 2 to actuate the brake device 6 and causes the electric motor 52 to actuate the brake device 6 at the same time or with a delay when the parking ability determination unit 24 determines that the necessary braking force cannot be obtained.”.

In the parking brake devices for vehicles described in Patent Literatures 1 and 2, the fluid pressure (brake fluid pressure) of the wheel cylinder is increased by the service brake so as to compensate for the shortage of the braking force (that is, the pressing force of the friction member against the rotating member) when the parking brake is applied. For example, in Patent Literatures 1 and 2, a fluid pressure unit for vehicle stabilization control (so-called ESC, also referred to as “driving dynamic control” or “vehicle stability control”) is used as a unit for automatically pressurizing the brake fluid pressure.

The applicant has developed a parking brake device for a vehicle as described in Patent Literature 3. In the devices of Patent Literatures 1 and 2, when the parking brake is applied, the pressing force shortage is compensated by the automatic pressurization of the brake fluid pressure. On the other hand, in the device of Patent Literature 3, assistance by automatic pressurization is performed when the parking brake is released.

Incidentally, in the fluid pressure unit for vehicle stabilization control, generally, the brake fluid is moved from the master cylinder side to the wheel cylinder side via the pressure regulating valve, whereby the brake fluid pressure is automatically increased. Therefore, when the brake fluid pressure is increased, the displacement of the braking operation member (brake pedal) may be affected. Specifically, due to the movement of the brake fluid, the braking operation member is slightly moved to the master cylinder side. This phenomenon is called “retraction” of the braking operation member. In the parking brake device in which the actuation (that is, application and/or release of the parking brake) of the parking brake is assisted by the automatic pressurization in the fluid unit, it is desired to suppress the retraction phenomenon.

### CITATIONS LIST

### Patent Literatures

Patent Literature 1: JP 2007-519568 A
Patent Literature 2: JP 2020-050004 A
Patent Literature 3: JP 2013-244888 A

### SUMMARY

### Technical Problems

An object of the present disclosure is to provide a parking brake device in which pressurization by a fluid unit is used when a parking brake is actuated, the parking brake device being capable of suppressing retraction of a braking operation member.

### Solutions to Problems

A parking brake device according to the present disclosure includes: “a fluid unit (HU) including a fluid pump (QA) that suctions a brake fluid (BF) from a master cylinder (CM) using a first electric motor (MA) as a motive power source, and a pressure regulating valve (UA) that increases a pressure of the brake fluid (BF) discharged by the fluid pump (QA) and supplies the increased pressure to a wheel cylinder (CW) as a brake fluid pressure (Pw), the fluid unit (HU) causing the brake fluid pressure (Pw) to press a friction member (MS) against a rotating member (KT) fixed to vehicle wheels (WH) of a vehicle to generate a braking force (Fm)”; “an electrically-powered unit (DU) that uses a second electric motor (ME) as a motive power source and generates the braking force (Fm) on a parking wheel (WHp) on which a parking brake is applied among the vehicle wheels (WH)”; and “a controller (ECU) that controls the fluid unit (HU) and the electrically-powered unit (DU)”. Furthermore, the controller (ECU) increases only the brake fluid pressure (Pwp) corresponding to the parking wheel (WHp) in the wheel cylinder (CW) in a case where the parking brake is actuated.

In the parking brake device according to the present disclosure, the parking wheel (WHp) is a rear wheel (WHr) of the vehicle, and the non-parking wheel (WHn) is a front wheel (WHf) of the vehicle. In addition, the fluid unit (HU) includes, as the pressure regulating valves (UA), a front wheel pressure regulating valve and a rear wheel pressure regulating valve (UAf, UAr) that are normally opened in front-rear type braking systems (BKf, BKr). Furthermore, in a case where the parking brake is actuated, the controller (ECU) does not energize the front wheel pressure regulating valve (UAf) but energizes only the rear wheel pressure regulating valve (UAr).

In the parking brake device according to the present disclosure, the parking wheel (WHp) is a rear wheel (WHr) of the vehicle, and the non-parking wheel (WHn) is a front wheel (WHf) of the vehicle. Furthermore, the fluid unit (HU) includes, as the pressure regulating valves (UA), a first-side pressure regulating valve and a second-side pressure regulating valve (UAi, UAj) that are normally opened in diagonal type braking systems (BKi, BKj). Additionally, the fluid unit (HU) includes a front wheel inlet vale and a rear wheel inlet valve (VIf, VIr) that are normally opened between the first-side and second-side pressure regulating valves (UAi, UAj) and the wheel cylinder (CW). Furthermore, the controller (ECU) energizes the front wheel inlet valve (VIf) to close the front wheel inlet valve (VIf), keep the rear wheel inlet valve (VIr) open without energizing the rear wheel inlet valve (VIr), and energize the first-side and second-side pressure regulating valves (UAi, UAj) in a case where the parking brake is actuated.

According to the above configuration, in the application assisting control when the parking brake is actuated, the movement amount of the brake fluid BF from the master reservoir RV to the master cylinder CM is limited. As a result, the retraction of the braking operation member BP can be reduced. As a result, discomfort to a driver is suppressed.

### BRIEF DESCRIPTION OF DRAWINGS

FIG. 1 is a schematic view for explaining a first embodiment of a parking brake device EP for a vehicle according to the present disclosure.

FIG. 2 is a schematic view including a cross-sectional view for explaining an electrically-powered unit DU or the like.

FIG. 3 is a flowchart for explaining processing of application control including auxiliary pressurization control.

FIG. 4 is a time-series diagram for explaining operation of the application control.

FIG. 5 is a flowchart for explaining processing of release control including auxiliary pressurization control.

FIG. 6 is a time-series diagram for explaining operation of the release control.

FIG. 7 is a schematic view for explaining a second embodiment of the parking brake device EP for a vehicle according to the present disclosure.

### DESCRIPTION OF EMBODIMENTS

Embodiments of a parking brake device EP for a vehicle according to the disclosure here will be described with reference to the drawings.

### <Symbols or the Like of Constituent Members or the Like>

In the following description, components such as members, signals, values, and the like denoted by the same symbol such as “CW” or the like have the same function. The subscripts “f” and “r” attached to the end of various symbols related to the vehicle wheel are comprehensive symbols indicating which of the front wheel and the rear wheel the elements relate to. Specifically, “f” indicates “an element related to the front wheel”, and “r” indicates “an element related to the rear wheel”. For example, in wheel cylinders CW, it is described as “front wheel cylinder CWf, rear wheel cylinder CWr”. Furthermore, the subscripts “f” and “r” are omitted in some cases. In a case where these are omitted, each symbol represents the collective designation thereof.

### Front-Rear Type Braking Systems

Furthermore, in the configuration (see the first embodiment) in which the front-rear type (also referred to as “type II”) is adopted as the two braking systems (braking pipes), the subscripts “f” and “r” attached to the end of the symbols are comprehensive symbols indicating which system the subscripts relate to. Specifically, the subscript “f” indicates “correspondence to the front wheel braking system BKf”, and the subscript “r” indicates “correspondence to the rear wheel braking system BKr”. For example, “CWf” is a wheel cylinder related to the front wheel braking system BKf (that is, the front wheel cylinder), and “CWr” is a wheel cylinder related to the rear wheel braking system BKr (that is, the rear wheel cylinder). Similarly to the above, the subscripts “f” and “r” are omitted in some cases. In this case, the symbol represents the collective designation in the front wheel and rear wheel braking systems BKf, BKr. That is, the term “wheel cylinders CW” is the collective designation of the front wheel cylinder and the rear wheel cylinder CWf, CWr.

### Diagonal Type Braking Systems

In addition, in the configuration (see the second embodiment) in which the diagonal type (also referred to as “X type”) is adopted as the two braking systems (braking pipes), the subscripts “i” and “j” attached to the end of the symbols are comprehensive symbols indicating which system the subscripts relate to. Specifically, the subscript “i” indicates “correspondence to the first-side braking system”, and the subscript “j” indicates “correspondence to the second-side braking system”. Furthermore, in the configuration in which the diagonal type braking system is adopted, the subscript “f” indicates “correspondence to the front wheel WHf”, and the subscript “r” indicates “correspondence to the rear wheel WHr”. For example, “VIf” belonging to “BKi” indicates a “front wheel inlet valve VIf in the first-side braking system BKi”. Similarly to the above, the subscripts “i” and “j” may be omitted. In this case, the symbol represents the collective designation.

### Direction of Action/Movement

In the direction of action/movement of the member related to the friction member MS (friction member MS itself, brake piston PN, output member SB, and the like), the “advancing direction Ha” corresponds to the “direction in which the friction member MS approaches the rotating member KT”, and the “retreating direction Hb (direction opposite to the advancing direction Ha)” corresponds to the “direction in which the friction member MS separates from the rotating member KT”. Therefore, when the member related to the friction member MS is moved in the advancing direction Ha, the pressing force Fm (a force by which the friction member MS is pressed against the rotating member KT, also referred to as “braking force”) of the friction member MS with respect to the rotating member KT is increased. Conversely, when the member related to the friction member MS is moved in the retreating direction Hb, the braking force (pressing force) Fm is reduced.

In the rotation direction of the second electric motor ME, the “forward rotation direction Da” corresponds to the movement in the retreating direction Hb. The “reverse rotation direction db (rotation direction opposite to the forward rotation direction Da)” of the second electric motor ME corresponds to the retreating direction Hb. That is, when the second electric motor ME is rotated in the forward rotation direction Da, the friction member MS is moved in the advancing direction Ha, and the braking force Fm is increased. Conversely, when the second electric motor ME is rotated in the reverse rotation direction db, the friction member MS is moved in the retreating direction Hb, and the braking force Fm is reduced.

Finally, the relationship between the directions of action/movement of a first master piston and a second master piston NP, NS of the master cylinder CM and the braking force Fm will be described. In the first and second master pistons NP, NS, the “advancing direction Hf” is a “direction corresponding to the advancing direction Ha of the friction member MS”, and the “retreating direction Hr” is a “direction corresponding to the retreating direction Hb of the friction member MS”. When the first and second master pistons NP, NS are moved in the advancing direction Hf, the brake fluid BF is discharged from the master cylinder CM toward the wheel cylinders CW. As a result, the fluid pressure Pw (referred to as “brake fluid pressure”) of the wheel cylinders CW is increased, the friction member MS is moved in the advancing direction Ha, and the braking force Fm is increased. Conversely, when the first and second master pistons NP, NS are moved in the retreating direction Hr, the brake fluid BF is returned from the wheel cylinders CW toward the master cylinder CM. As a result, the fluid pressure Pw of the wheel cylinders CW is decreased, the friction member MS is moved in the retreating direction Hb, and the braking force Fm is decreased.

### <First Embodiment of Parking Brake Device EP>

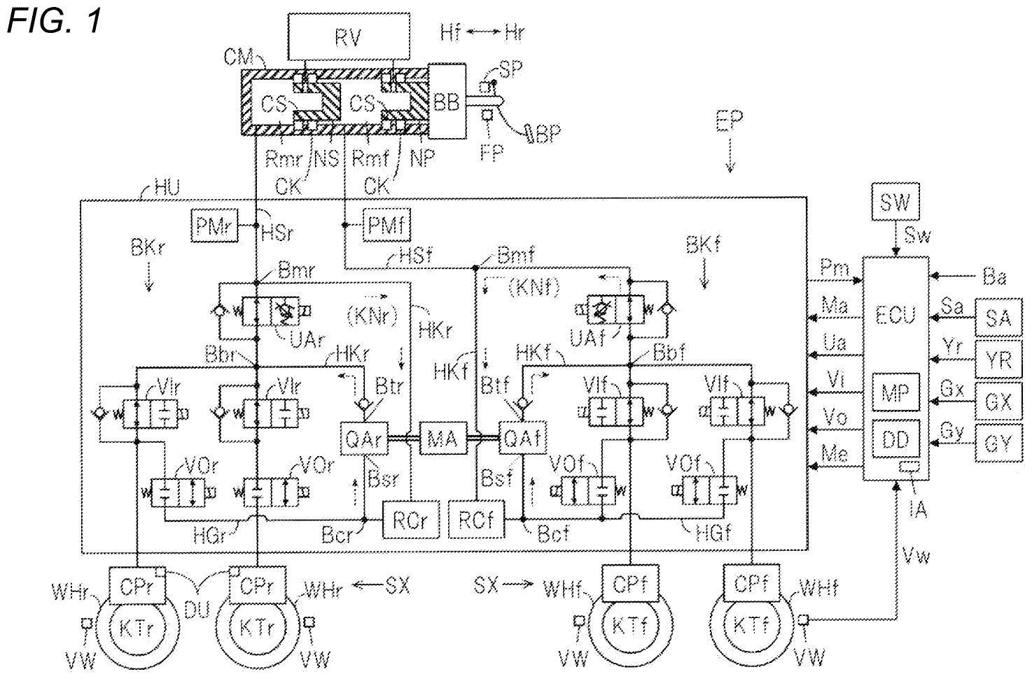

A first embodiment of the parking brake device EP will be described with reference to a schematic view of FIG. 1. A vehicle equipped with the parking brake device EP includes a braking operation member BP, a parking brake switch SW, a master reservoir RV, a master cylinder CM, a braking device SX, a fluid unit HU, various sensors (VW or the like), a controller ECU, and the parking brake device EP. In the first embodiment of the parking brake device EP, a so-called front-rear type (also referred to as “type II”) is adopted in the braking system related to the master cylinder CM and the fluid unit HU. That is, in the tandem type master cylinder CM, two fluid pressure chambers (a front wheel master chamber and a rear wheel master chamber) Rmf, Rmr (=Rm) are respectively connected to the front wheel and rear wheel cylinders CWf, CWr (=CW) via a front wheel communication path and a rear wheel communication path HSf, HSr (=HS).

The braking operation member (for example, a brake pedal) BP is a member operated by the driver to decelerate the vehicle. The parking brake switch (also simply referred to as “parking switch”) SW is a switch operated by the driver, and outputs an on or off signal Sw (referred to as “parking signal”). Specifically, application (actuation) of the parking brake is instructed so that the parking brake becomes effective in the on state of the parking signal Sw. Conversely, release (actuation) of the parking brake is instructed so that the parking brake is not applied in the off state of the parking signal Sw.

The master reservoir (also referred to as “atmospheric pressure reservoir”) RV is a tank for actuation liquid, and the brake fluid BF is stored therein. The master cylinder CM is a cylinder member having a bottom portion. The first and second master pistons NP, NS are inserted into the master cylinder CM, and the inside thereof is sealed by cup seals CS, CK to be divided into the front wheel master chamber and the rear wheel master chamber Rmf, Rmr. That is, the master cylinder CM is a tandem type. The front wheel and rear wheel master chambers Rmf, Rmr of the master cylinder CM are connected to the master reservoir RV. Furthermore, the front wheel and rear wheel master chambers Rmf, Rmr (=Rm) are respectively connected to the front wheel and rear wheel cylinders CWf, CWr (=CW) through the front wheel and rear wheel communication paths HSf, HSr (=HS).

The first and second master pistons NP, NS are mechanically connected to the braking operation member BP via a brake rod RD or the like. The master cylinder CM is provided with a brake booster BB so that the operation force Fp of the braking operation member BP by the driver is assisted. When the braking operation member BP is operated, the first and second master pistons NP, NS are moved in the advancing direction Hf (direction in which the volume of the master chambers Rm decreases). As a result, the brake fluid BF is moved from the master cylinder CM with respect to the wheel cylinders CW, and the fluid pressure (brake fluid pressure) Pw in the wheel cylinders CW is increased. In the vehicle equipped with the parking brake device EP, the relationship between the operation force Fp and operation displacement Sp in the braking operation member BP (that is, the operation characteristic of the braking operation member BP) is determined by the rigidity (spring constant) of the power transmission member (braking operation member BP itself, master cylinder CM, braking pipe, brake caliper CP, friction member MS, and the like) from the braking operation member BP to the friction member MS. That is, a brake-by-wire type braking control device in which the operation characteristic of the braking operation member BP is generated by a stroke simulator is not adopted in the vehicle.

The braking device SX includes a rotating member (for example, a brake disc) KT and the brake caliper CP. The rotating member KT is fixed to a vehicle wheel WH so as to rotate integrally with the vehicle wheel WH. The brake caliper CP is provided so as to sandwich the rotating member KT. The brake caliper CP is provided with the wheel cylinder CW. As will be described later, the brake fluid BF regulated to a regulated fluid pressure Pq (=Pm+mQ) is supplied from the fluid unit HU to the wheel cylinders CW as the brake fluid pressure Pw. In the braking device SX, the braking force Fm is generated on the vehicle wheel WH according to the brake fluid pressure Pw. Here, the “braking force Fm” is a force by which the friction member (for example, a brake pad) MS is pressed against the rotating member KT, and is also called “pressing force”.

### <<Fluid Unit HU>>

The fluid unit HU is provided between the master cylinder CM and the wheel cylinders CW. The fluid unit HU is used for anti-lock brake control (control for suppressing locking of the vehicle wheels WH, so-called ABS control), traction control (control for suppressing idling of the vehicle wheels WH), vehicle stability control (control for suppressing excessive understeer/oversteer of a vehicle, so-called ESC), and the like. In order to execute these controls, the brake fluid pressure Pw is individually controlled in each wheel cylinder CW independently of the fluid pressure (master cylinder fluid pressure) Pm of the master cylinder CM by the fluid unit HU.

The fluid unit HU includes pressure regulating valves UA (=UAf, UAr), fluid pumps QA (=QAf, QAr), an electric motor MA, pressure regulating reservoirs RC (=RCf, RCr), master cylinder fluid pressure sensors PM (=PMf, PMr), inlet valves VI (=VIf, VIr), and outlet valves VO (=VOf, VOr).

The front wheel pressure regulating valve and the rear wheel pressure regulating valve UAf, UAr (=UA) are provided in the front wheel communication path and the rear wheel communication path HSf, HSr (=HS). The pressure regulating valves UA (electromagnetic valve) are normally-opened linear valves (also referred to as “differential pressure valves” and “proportional valves”). Upper portions Bmf, Bmr (portions of the communication paths HS on the sides close to the master cylinder CM) of the pressure regulating valves UA and the lower portions Bbf, Bbr (portions of the communication paths HS on the sides close to the wheel cylinders CW) of the pressure regulating valves UA are connected by a front wheel reflux path and a rear wheel reflux path HKf, HKr (=HK). The reflux paths HK are provided with the front wheel fluid pump and the rear wheel fluid pump QAf, QAr (=QA), and the front wheel pressure regulating reservoir and the rear wheel pressure regulating reservoir RCf, RCr (=RC). The fluid pumps QA are driven by the electric motor MA.

In the fluid unit HU, the front wheel master cylinder fluid pressure sensor and the rear wheel master cylinder fluid pressure sensor PMf, PMr (=PM) are provided between the master cylinder CM and the pressure regulating valves UA so as to detect the actual fluid pressure (master cylinder fluid pressure) Pm supplied from the master cylinder CM. Since the fluid pressure Pmf of the front wheel master chamber Rmf (front wheel master cylinder fluid pressure) and the fluid pressure Pmr of the rear wheel master chamber Rmr (rear wheel master cylinder fluid pressure) are substantially equal, either one of the front wheel and rear wheel master cylinder fluid pressure sensors PMf, PMr may be omitted.

The fluid pumps QA are driven by the electric motor MA. Here, the electric motor MA is also referred to as “reflux electric motor” or a “first electric motor” in order to be distinguished from an electric motor ME (for a parking brake) to be described later. When the first electric motor MA is rotationally driven, the brake fluid BF is suctioned from the upper portions Bm of the pressure regulating valves UA and discharged to lower portions Bb of the pressure regulating valves UA by the fluid pumps QA. As a result, a front wheel circulation flow and a rear wheel circulation flow KNE, KNr (=KN) (flow of the circulating brake fluid BF, which is also simply referred to as “reflux”) of the brake fluid BF including the pressure regulating valves UA, the fluid pumps QA, and the pressure regulating reservoirs RC are generated in the communication paths HS and the reflux paths HK. When the refluxes KN are narrowed by the pressure regulating valves UA, the fluid pressure Pq (referred to as “regulated fluid pressure”) of the lower portions Bb of the pressure regulating valves UA are increased from the fluid pressure Pm (master cylinder fluid pressure) of the upper portions of the pressure regulating valves UA by the orifice effect. In other words, a fluid pressure difference mQ (also referred to as “differential pressure”) between the master cylinder fluid pressure Pm and the regulated fluid pressure Pq is regulated by the fluid unit HU. The regulated fluid pressure Pq increased by the pressure regulating valves UA is supplied to the wheel cylinders CW as the brake fluid pressure Pw.

Inside the fluid unit HU, the front wheel and rear wheel communication paths HSf, HSr are branched into two and connected to the front wheel and rear wheel cylinders CWf, CWr, respectively. The inlet valve VI and the outlet valve VO are provided for each wheel cylinder CW. The inlet valves VI (electromagnetic valves) are normally-opened on/off valves. The inlet valves VI are provided in the branched communication paths HS (that is, the sides closer to the wheel cylinders CW with respect to branching portions Bbf, Bbr of the communication paths HS). The communication paths HS are connected to the pressure regulating reservoirs RC via pressure reducing paths HG at lower portions of the inlet valves VI (portions of the communication paths HS on sides close to the wheel cylinders CW). The pressure reducing paths HG are provided with outlet valves VO. The outlet valves VO (electromagnetic valves) are normally-closed on/off valves.

When the inlet valves VI and the outlet valves VO are not controlled (that is, in the case of both the non-energized states), the brake fluid pressure Pw is increased by the differential pressure mQ with respect to the master cylinder fluid pressure Pm. On the other hand, when the brake fluid pressure Pw needs to be regulated for each wheel cylinder CW by the anti-lock brake control or the like, the inlet valves VI and the outlet valves VO are individually controlled. Specifically, in order to reduce the brake fluid pressure Pw, the inlet valves VI are closed and the outlet valves VO are opened. Since the inflow of the brake fluid BF into the wheel cylinders CW is prevented and the brake fluid BF in the wheel cylinders CW flows out to the pressure regulating reservoirs RC, the brake fluid pressure Pw is reduced. In order to increase the brake fluid pressure Pw, the inlet valves VI are opened and the outlet valves VO are closed. Since the outflow of the brake fluid BF to the pressure regulating reservoirs RC is prevented and the regulated fluid pressure Pq regulated by the pressure regulating valves UA is supplied to the wheel cylinders CW, the brake fluid pressure Pw is increased. In order to maintain the brake fluid pressure Pw, both the inlet valves VI and the outlet valves VO are closed. Since the wheel cylinders CW are fluidly sealed, the brake fluid pressure Pw is maintained constant.

### Cause of Occurrence of Retraction Phenomenon of Braking Operation Member BP

Hereinafter, a retraction phenomenon (phenomenon in which the braking operation member BP is moved in the advancing direction Hf) that may occur when the differential pressure mQ (fluid pressure difference between the master cylinder fluid pressure Pm and the regulated fluid pressure Pq) is increased will be described.

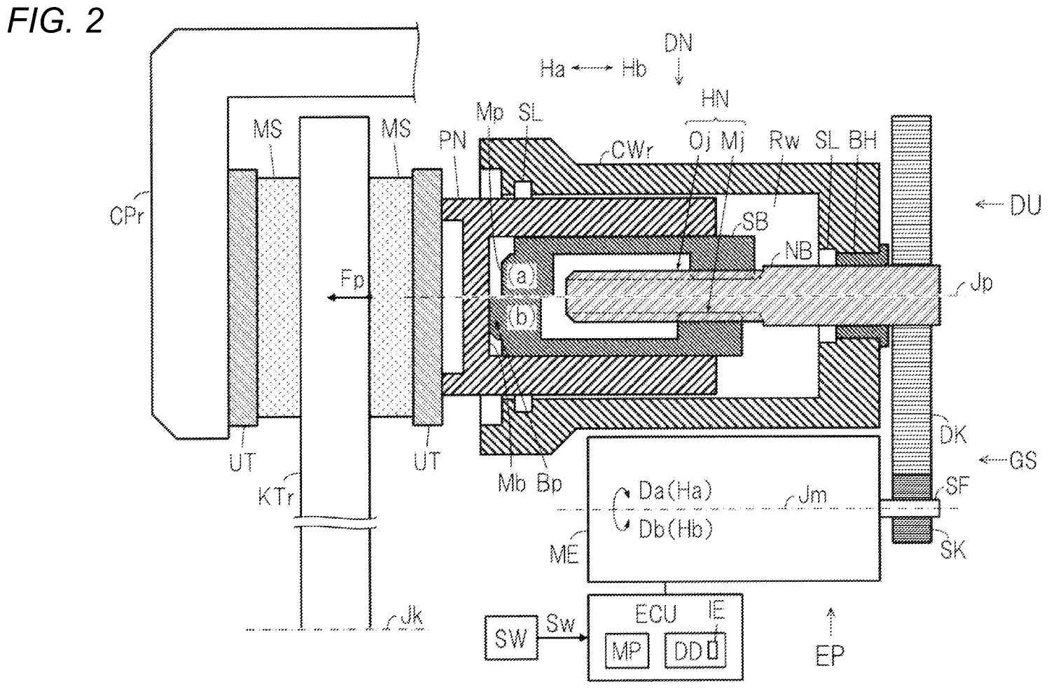

When the brake fluid pressure Pw is increased, the brake piston PN in the wheel cylinders CW is moved in the advancing direction Ha (see FIG. 2). At this time, the volume in the wheel cylinders CW is increased, and the amount of the brake fluid BF in the wheel cylinder CW is increased. That is, when the brake fluid pressure Pw is increased and the brake piston PN is moved forward, the brake fluid BF having a volume corresponding to the movement amount of the brake piston PN is consumed in the wheel cylinders CW.

Next, cup seals CS, CK for sealing the master cylinder CM and the first master piston and the second master piston NP, NS will be described. The master cylinder CM has a bottomed cylindrical hole formed by the closed bottom surface and an inner peripheral surface of the cylindrical hole. The first and second master pistons NP, NS are inserted into the bottomed cylindrical hole of the master cylinder CM. Outer peripheral surfaces of the first and second master pistons NP, NS and the inner peripheral surface of the master cylinder CM are sealed by two types of cup seals CS, CK. Here, of the two types of cup seals, one on the side in the advancing direction Hf (the side close to the bottom portion of the master cylinder CM and away from the braking operation member BP) is referred to as a “tip seal CS”, and one on the side in the retreating direction Hr (the side away from the bottom portion of the master cylinder CM and close to the braking operation member BP) is referred to as a “rear end seal CK”.

The sealability of the tip seal CS (one of the two types of cup seals) depends on the flowing direction of the brake fluid BF (that is, it has directivity). Specifically, in the tip seal CS, a seal function (a function of preventing the liquid BF from leaking) is exerted in a direction from the master chambers Rm to the master reservoir RV. On the other hand, in the direction from the master reservoir RV to the master chambers Rm, the movement of the brake fluid BF is permitted via the lip portion of the tip seal CS (portion in sliding contact with the inner peripheral portion of the master cylinder CM). On the other hand, the sealing function of the rear end seal SK (the other of the two types of cup seals) is exerted without depending on the flow direction of the brake fluid BF.

In a case where the braking operation member BP is not operated (that is, in the case of “Ba=0”), the master reservoir RV and the master chambers Rm (=Rmf, Rmr) communicate with each other. Therefore, the brake fluid BF is suctioned from the master reservoir RV without a load through the master cylinder CM. That is, when the braking operation member BP is not operated, the amount of the brake fluid BF accompanied by the increase in the volume in the wheel cylinders CW is supplied from the master reservoir RV in communication with the master cylinder CM. Here, the amount of the brake fluid BF suctioned from the master reservoir RV accompanied by the increase in the volume in the wheel cylinders CW is referred to as “suction amount”.

When the braking operation member BP is operated, the first and second master pistons NP, NS are moved in the advancing direction Hf. Communication between the master reservoir RV and the master chambers Rm is blocked by movement of the first and second master pistons NP, NS. In this case, the amount (that is, the suction amount) of the brake fluid BF accompanied by the increase in volume in the wheel cylinders CW is supplied from the master reservoir RV through the lip portion of the cup seal CS (tip seal). When the fluid pumps QA are driven by the first electric motor MA, the fluid pumps QA also suction the brake fluid BF from the master chambers Rm. That is, the brake fluid BF is also supplied from the master reservoir RV via the cup seal CS (tip seal). At this time, in the movement of the brake fluid BF, resistance (suction resistance) at the cup seal CS exists. Therefore, the first and second master pistons NP, NS are moved in the advancing direction Hf. As a result, the driver may feel the retraction (movement in the advancing direction Hf) of the braking operation member BP as discomfort. The degree of the retraction phenomenon depends on the amount (suction amount) of the brake fluid BF flowing through the cup seal CS. That is, the greater the suction amount of the brake fluid BF, the greater the degree of retraction of the braking operation member BP.

As described above, the retraction phenomenon occurs when the brake fluid BF is moved from the master reservoir RV to the master cylinder CM via the cup seal CS in a state where the communication between the master reservoir RV and the master cylinder CM is blocked. Therefore, the braking operation characteristic (referred to as “Sp-Fp characteristic”), which is the relationship between the operation displacement Sp and the operation force Fp, cannot occur in the brake-by-wire configuration formed by the stroke simulator. Therefore, in the vehicle to which the parking brake device EP is applied, the braking operation characteristic (Sp-Fp characteristic) is generated by the rigidity (elasticity) of the power transmission member (brake caliper CP, friction member MS, etc.) from the braking operation member BP to the friction member MS.

### <<Various Sensors>>

The vehicle includes various sensors listed below. Detection signals (Vw or the like) of these sensors are input to the controller ECU.
A braking operation amount sensor BA that detects an operation amount (braking operation amount) Ba of the braking operation member BP. Here, the braking operation amount Ba is a collective designation, and specifically, at least one of the master cylinder fluid pressure Pm, the operation displacement Sp of the braking operation member BP, and the operation force Fp of the braking operation member BP corresponds to the braking operation amount Ba. Therefore, at least one of the master cylinder fluid pressure sensors PM that detects the master cylinder fluid pressure Pm, the operation displacement sensor SP that detects the operation displacement Sp, and the operation force sensor FP that detects the operation force Fp is provided as the braking operation amount sensor BA.
A steering operation amount sensor SA that detects an operation amount (a steering operation amount, for example, a steering angle) Sa of a steering operation member SH (not illustrated).
A vehicle wheel speed sensor VW that detects a rotational speed (vehicle wheel speed) Vw of the vehicle wheel WH.
In a vehicle (in particular, the vehicle body), a yaw rate sensor YR that detects a yaw rate Yr, a longitudinal acceleration sensor GX that detects a longitudinal acceleration Gx, and a lateral acceleration sensor GY that detects a lateral acceleration Gy.

### <<Controller ECU>>

The controller ECU includes a microprocessor MP and a drive circuit DD. The fluid unit HU is controlled by the controller ECU. Specifically, drive signals Ua of the pressure regulating valves UA, drive signals Vi of the inlet valves VI, drive signals Vo of the outlet valves VO, and a drive signal Ma of the electric motor MA are calculated so as to execute anti-lock brake control, traction control, vehicle stability control, and the like on the basis of detection signals (Vw or the like) of various sensors and a control algorithm in the microprocessor MP.

The drive circuit DD is formed of a switching element (power semiconductor devices such as MOS-FETs, IGBTs, and the like). The drive circuit DD is controlled according to the drive signal (Ua or the like), and the electromagnetic valve “UA, VI, VO” and the electric motor MA constituting the fluid unit HU are driven. The drive circuit DD is provided with a front wheel energization amount sensor and a rear wheel energization amount sensor (for example, current sensors) IAf, IAr (=IA) so as to detect the energization amounts (an energization amount of the front wheel and the rear wheel, for example, current values) Iaf, Iar (=Ia) of the front wheel and rear wheel pressure regulating valves UAf, UAr.

### <<Parking Brake Device EP>>

The parking brake device EP includes an electrically-powered unit DU, the fluid unit HU, and the controller ECU. The braking force Fm is regulated (increased or decreased) by the parking brake device EP, and the parking brake is operated. The electrically-powered unit DU is provided on a brake caliper CPr of the braking device SXr provided on a rear wheel WHr (rear wheel caliper) so as to regulate the braking force Fm. Further, the fluid unit HU is controlled to support (assist) the regulation of the braking force Fm by the electrically-powered unit DU in addition to the execution of the vehicle stability control or the like. The control of the parking brake is programmed in the microprocessor MP of the controller ECU. The pressurization control by the fluid unit HU when the parking brake is operated is referred to as “auxiliary pressurization control”.

### Parking Wheel WHp and Non-Parking Wheel WHn

In the following description, among the plurality of vehicle wheels WH of the vehicle, a vehicle wheel on which the parking brake is applied (a vehicle wheel provided with the electrically-powered unit DU) is referred to as “parking wheel WHp”, and a vehicle wheel on which the parking brake is not applied (a vehicle wheel not provided with the electrically-powered unit DU) is referred to as “non-parking wheel WHn”. Among the plurality of wheel cylinders CW, the wheel cylinder corresponding to the parking wheel WHp is referred to as “parking wheel cylinder CWp”, and the wheel cylinder corresponding to the non-parking wheel WHn is referred to as “non-parking wheel cylinder CWn”. Furthermore, the fluid pressure of the parking wheel cylinder CWp is referred to as “parking brake fluid pressure Pwp”, and the fluid pressure of the non-parking wheel cylinder CWn is referred to as “non-parking brake fluid pressure Pwn”. In general, the parking brake is operated on the rear wheels WHr. In this configuration, the front wheels WHf are the non-parking wheels WHn, and the rear wheels WHr are the parking wheels WHp. The front wheel cylinders CWf are the non-parking wheel cylinders CWn, and the rear wheel cylinders CWr are the parking wheel cylinders CWp. Furthermore, the front wheel brake fluid pressure Pwf is the non-parking brake fluid pressure Pwn, and the rear wheel brake fluid pressure Pwr is the parking brake fluid pressure Pwp.

### <Electrically-Powered Unit DU>

The electrically-powered unit DU or the like of the parking brake device EP will be described with reference to a schematic view of FIG. 2. The electrically-powered unit DU is controlled by the controller ECU. The electrically-powered unit DU includes an electric motor ME, a speed reducer GS, an input member NB, and an output member SB. Here, the electrically-powered unit DU is provided on the rear wheel caliper CPr. That is, in the example, the front wheels WHf are the non-parking wheels WHn, the rear wheels WHr are the parking wheels WHp, the front wheel cylinders CWf are the non-parking wheel cylinders CWn, and the rear wheel cylinders CWr are the parking wheel cylinders CWp.

The electric motor ME is a motive power source for generating the braking force Fm. The electric motor ME is also referred to as “parking electric motor” or “second electric motor” in order to be distinguished from the reflux electric motor (first electric motor) MA. The output of the second electric motor ME (the rotational power of an output shaft SF) is input to the speed reducer GS. For example, a small-diameter gear SK is fixed to the output shaft SF of the electric motor ME. The small-diameter gear SK is interlocked with a large-diameter gear DK. That is, the small-diameter gear SK and the large-diameter gear DK constitute the speed reducer GS.

The input member NB is fixed to the large-diameter gear DK. The rotational power of the second electric motor ME is decelerated by the speed reducer GS and transmitted to the input member NB. The input member NB is inserted into the fluid pressure chamber Rw through an insertion hole formed in the rear wheel cylinder CWr (in particular, the body part of the wheel cylinder CWr). The input member NB is held by a bearing member BH and sealed by a seal member SL. A male screw Oj is formed on an outer peripheral surface of the input member NB.

The output member SB is engaged with the input member NB. Specifically, the output member SB is formed as a hollow cylindrical member, and a female screw Mj is formed on an inner wall surface thereof. The female screw Mj is screwed with the male screw Oj of the input member NB. That is, the input member NB (in particular, the male screw Oj) and the output member SB (in particular, the female screw Mj) constitute a rotation/linear motion conversion mechanism HN (also referred to as “power conversion mechanism”) that converts rotational motion into linear motion. The power conversion mechanism HN includes a whirl-stop prevention mechanism (for example, a key mechanism, a mechanism having a width across flats). The power conversion mechanism HN adopts a self-locking configuration (a configuration in which the friction member MS is movable from the electric motor ME but the electric motor ME cannot be rotated from the friction member MS, also referred to as “configuration with zero reverse efficiency”).

The output member SB is inserted into a cylindrical portion of the brake piston PN. Then, the output member SB is linearly moved along the rotation axis (that is, a central axis line Jp of the brake piston PN) of the input member NB, whereby the braking force Fm is generated. Specifically, a state in which the parking brake is released (a state in which the parking brake is not effective) is illustrated on the upper side of the central axis line Jp in (a). In this state, an end surface Mp of a projection Bp of the output member SB is away from a cylindrical bottom surface Mb of the brake piston PN, and the brake piston PN is not pressed by the output member SB.

When the actuation of the parking brake is started, the output member SB is moved in the advancing direction Ha and presses the brake piston PN. This state is illustrated in (b) below the central axis line Jp. The projection end surface Mp of the output member SB abuts on the cylindrical bottom surface Mb of the brake piston PN, and the brake piston PN is pressed by the output member SB. Since the brake piston PN is disposed to press a back plate UT of the friction member MS, the friction member MS is pressed against the rotating member KT by the linear movement of the output member SB (as a result, the brake piston PN), and the braking force Fm is generated. Since the self-lock configuration is adopted for the power conversion mechanism HN, when the desired braking force Fm is achieved, the braking force Fm is maintained even if the driving (energization) of the second electric motor ME is stopped.

The rear wheel cylinder CWr (=CWp) is also used for a service brake (also referred to as “regular brake”). The braking force Fm (pressing force of the friction member MS against the rotating member KT) is also increased by increasing the pressure (parking brake fluid pressure) Pwr (=Pwp) in the fluid pressure chamber Rw of the rear wheel cylinder CWr by the auxiliary pressurization control. That is, the brake piston PN is pressed by both the electrically-powered unit DU (in particular, the second electric motor ME) and the parking brake fluid pressure Pwp (fluid pressure supplied from the fluid unit HU). As a result, the braking force Fm, which is the force with which the friction member MS pushes the rear wheel rotating member KTr, is generated.

The electrically-powered unit DU (in particular, the second electric motor ME) is controlled by the controller ECU (electronic control unit). The parking signal Sw from the parking switch SW is input to the controller ECU. Then, a drive signal Me for controlling the second electric motor ME is calculated according to the parking signal Sw. The controller ECU also includes the drive circuit DD for driving the electric motor ME. In the drive circuit DD, a bridge circuit is formed by switching elements. The energization state of each switching element is controlled according to the drive signal Me, and the output of the electric motor ME is controlled. The drive circuit DD includes an energization amount sensor IE that detects an actual energization amount Ie of the electric motor ME. Here, the energization amount Ie is a state quantity representing the degree of energization to the second electric motor ME, and is, for example, a current value. As the energization amount sensor IE, a current sensor is employed, and the supply current Ie to the electric motor ME is detected.

### <Processing of Application Control>

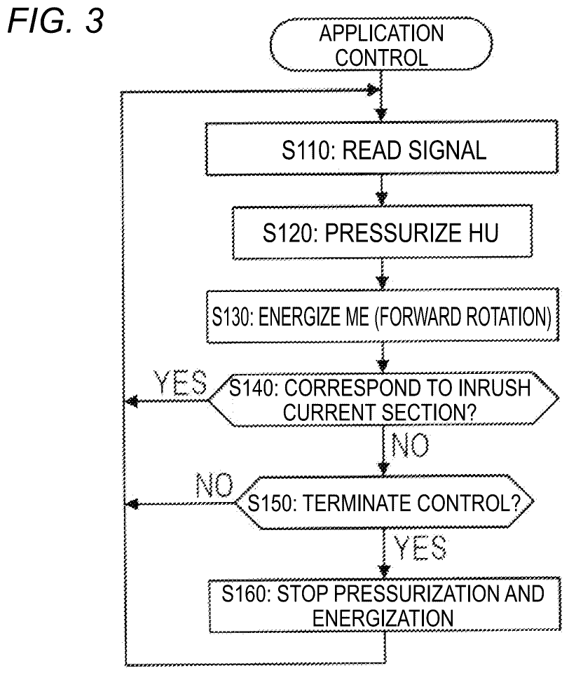

The processing of application control will be described with reference to the flowchart of FIG. 3. The “application control” is control for transitioning from the release state in which the parking brake is not effective to the application state in which the parking brake is effective. That is, the application control is control for subjecting the parking brake to application actuation. The application control is started with the time point at which the parking signal Sw is switched from off to on. Here, switching the parking signal Sw from off to on is called “application instruction”. Similarly to the above, since the electrically-powered unit DU is provided in the rear wheel calipers CPr, the electrically-powered unit DU satisfies “WHf=WHn, WHr=WHp”, “CWf=CWn, CWr=CWp”, and “Pwf=Pwn, Pwr=Pwp”.

In step S110, various signals including the parking signal Sw, the master cylinder fluid pressure Pm, the pressure regulating valve energization amount (for example, the current value) Ia, and the motor energization amount (for example, the current value) Ie are read. For example, the energization amount Ia (actual value) of the pressure regulating valves UA and the energization amount Ie (actual value) of the second electric motor ME are detected by the energization amount sensors IA, IE provided in the drive circuit DD. The energization amount sensor IE may be incorporated in the second electric motor ME.

In step S120, the auxiliary pressurization control is executed. In the auxiliary pressurization control, the rear wheel brake fluid pressure Pwr (that is, the parking brake fluid pressure Pwp) is increased and the braking force Fm is increased by the fluid unit HU. In the auxiliary pressurization control, a certain ratio is borne by the rear wheel brake fluid pressure Pwr in the generation of the braking force Fm. As a result, the load on the second electric motor ME is reduced. Specifically, a rear wheel target differential pressure Qtr (target value) corresponding to a rear wheel differential pressure mQr (that is, the rear wheel cylinder CWr) in the rear wheel braking system BKr (difference between master cylinder fluid pressure Pm and rear wheel brake fluid pressure Pwr, actual value) is calculated with the time point at which the application instruction is issued as a starting point. Then, the rear wheel target differential pressure Qtr is increased with an increase gradient kj until the rear wheel brake fluid pressure Pwr reaches an applied predetermined fluid pressure pj, and is maintained constant after reaching the applied predetermined fluid pressure pj. On the other hand, a front wheel target differential pressure Qtf related to the front wheel braking system BKf (that is, the front wheel cylinder CWf) is calculated to “0”. Here, the applied predetermined fluid pressure pj is a predetermined value (constant) set in advance.

In step S120, the driving of the first electric motor MA is started in a time point at which the application instruction is issued (a time point at which the parking signal Sw transitions from off to on, a corresponding calculation cycle). Although the front wheel pressure regulating valve UAf is not energized, the energization amount Iar is energized to the rear wheel pressure regulating valve UAr. Note that the front wheel inlet valve and the rear wheel inlet valve VIf, VIr and the front wheel outlet valve and the rear wheel outlet valve VOf, VOr are not energized. Specifically, in the front wheel braking system BKf not provided with the electrically-powered unit DU, since “Qtf=0” is satisfied, the front wheel pressure regulating valve UAf is not energized (that is, “Iaf=0”). On the other hand, in the rear wheel braking system BKr including the electrically-powered unit DU, the rear wheel energization amount Iar corresponding to the rear wheel target differential pressure Qtr is energized to the rear wheel pressure regulating valve UAr. In the pressure regulating valve UA, since the differential pressure mQ is regulated to increase as the energization amount Ia (pressure regulating valve energization amount) increases, the rear wheel energization amount Iar is determined based on the relationship (so-called IP characteristic of pressure regulating valve UA) of the differential pressure mQ with respect to the energization amount Ia and the rear wheel target differential pressure Qtr.

In the fluid pumps QA driven by the first electric motor MA, the front wheel circulation flow and the rear wheel circulation flow KNf, KNr of the brake fluid BF are generated in the front wheel and rear wheel braking systems BKf, BKr. Since the front wheel pressure regulating valve UAf is in the fully open state, the front wheel differential pressure mof is “0”, and the front wheel brake fluid pressure Pwf is equal to the master cylinder fluid pressure Pm. On the other hand, since the valve opening amount of the rear wheel pressure regulating valve UAr is decreased by the energization of the rear wheel energization amount Iar, the rear wheel differential pressure mor is generated, and the rear wheel brake fluid pressure Pwr is increased from the master cylinder fluid pressure Pm. When the rear wheel brake fluid pressure Pwr is equal to or higher than the applied predetermined fluid pressure pj, the rear wheel energization amount Iar is maintained constant so that the rear wheel brake fluid pressure Pwr matches the applied predetermined fluid pressure pj.

In step S130, the electric motor ME is energized so that the second electric motor ME is driven in the forward rotation direction Da. Specifically, at the time point of the application instruction, a positive sign (+) voltage is applied to the second electric motor ME. After the start of the energization, the application of the positive voltage to the electric motor ME is continued. As a result, a positive sign (+) current is supplied to the electric motor ME, and the electric motor ME continues to be driven in the forward rotation direction Da.

In step S140, “corresponding to an inrush current section or not” is determined. The “inrush current” is a large current that temporarily flows exceeding a steady current value at an initial stage when the electric device (for example, an electric motor) is powered on, and is also called “start current”. The “inrush current section” is a section (period) in which the inrush current can be generated. The determination of the inrush current section is performed to eliminate the influence of the inrush current in the determination of step S150.

For example, in step S140, “corresponding to the inrush current section or not” is determined based on the actual energization amount Ie (motor energization amount). In step S140, after the energization of the second electric motor ME is started, the previous value Ie [n−1] of the motor energization amount Ie and the current value Ie [n] of the energization amount Ie are compared (here, “n” represents a calculation cycle). Then, the termination of the inrush current section is determined at the time point when the state in which a change amount dI (time differential value of energization amount Ie, also referred to as “energization change amount”) for a time T is less than a predetermined change amount dj (referred to as “application determination change amount”) in the actual energization amount Ie from the start of the energization of the electric motor ME is continued over an application determination time tj. Here, the application determination time tj and the application determination change amount dj are preset constants (predetermined values). In other words, in the “case where the energization change amount dI is equal to or larger than the application determination change amount dj” and the “case where the application determination time tj has not elapsed even when the energization change amount dI is less than the application determination change amount dj”, it is determined that the section is the inrush current section.

In addition, a time (period) during which the inrush current flows is known. Therefore, in step S140, the termination of the inrush current section may be determined on the basis of the fact that a specific application time tm has elapsed from an energization start time point to the second electric motor ME. Specifically, an application duration time Tj is calculated (integrated) from the time point when the energization to the second electric motor ME is started, and when the application duration time Tj is less than the predetermined time tm, it is determined “to correspond to the inrush current section”. On the other hand, when the application duration time Tj is equal to or longer than the predetermined time tm, it is determined “not to correspond to the inrush current section”. Here, the specific application time tm is a threshold value corresponding to the application duration time Tj for determining the termination of the inrush current section, and is a predetermined value (constant) set in advance.

In a case where it is determined in step S140 “to correspond to the inrush current section”, the process returns to step S110. On the other hand, in a case where it is determined in step S140 “not to correspond to the inrush current section”, the process proceeds to step S150.

In step S150, “whether or not to terminate application control (referred to as “termination determination”)” is determined based on the comparison between the motor energization amount Ie and an applied threshold amount ix (the termination threshold value of the application control). The termination determination is made based on “whether or not the actual energization amount Ie is equal to or larger than the applied threshold amount ix”. The applied threshold amount ix is set in advance as a value (predetermined constant) corresponding to a state in which the friction member MS and the rotating member KT are sufficiently pressed so that the parking brake becomes effective. In a case where “Ie≥ix” is satisfied and the result of step S150 is affirmative, the process proceeds to step S160. On the other hand, in a case where “Ie<ix” is satisfied and the result of step S150 is negative, the process returns to step S110.

In step S160, pressurization by the fluid unit HU and energization to the electric motor ME are stopped. That is, when the energization amount Ie reaches the applied threshold amount ix, the application control is terminated in step S160. Since the power conversion mechanism HN is self-locked, even if pressurization by the fluid unit HU and energization to the electric motor ME are stopped, the state in which the parking brake is effective (that is, the application state) is maintained.

Normally, in a state where the driver operates the braking operation member BP, an application instruction is issued, and the parking brake is applied. At the time of operating the braking operation member BP, since the master chambers Rm of the master cylinder CM and the master reservoir RV are in a non-communicating state (blocked state), the brake fluid BF is moved via the cup seal CS. A retraction phenomenon of the braking operation member BP occurs due to the suction resistance of the brake fluid BF at this time. The degree of retraction of the braking operation member BP (that is, the degree of suction resistance) depends on the flow rate of the brake fluid BF flowing through the cup seal CS.

In the application control of the parking brake device EP, the braking force Fm is generated by the fluid unit HU and the second electric motor ME. In the fluid unit HU, the front wheel brake fluid pressure Pwf (=Pwn) is not increased (pressurized) in the front wheel cylinder CWf (=CWn), and the fluid pressure Pwr (=Pwp) is increased (pressurized) only by the rear wheel cylinder CWr (=CWp). Specifically, the first electric motor MA is driven, and the brake fluid BF is suctioned and discharged by the fluid pumps QA (=QAf, QAr). At this time, the inlet valves VI, the outlet valves VO, and the front wheel pressure regulating valve UAf are in a non-energized state, and only the rear wheel pressure regulating valve UAr is energized. Then, the rear wheel differential pressure mQr is increased by the orifice effect when the circulation flow KNr is narrowed by the rear wheel pressure regulating valve UAr. As a result, the rear wheel brake fluid pressure Pwr is increased by the rear wheel differential pressure mor from the master cylinder fluid pressure Pm (=Pmr).

In the front wheel braking system BKf, since the front wheel pressure regulating valve UAf is in the fully open state, the brake fluid BF only circulates through the front wheel communication path HSf and the front wheel reflux path HKf. Therefore, since “mQf=0” is satisfied, the volume of the front wheel cylinder CWf does not increase, and the suction amount corresponding to the front wheel cylinder CWf is “0”. Since only the amount of the brake fluid BF corresponding to the increase in volume of the rear wheel cylinder CWr is suctioned, the suction amount is limited to the minimum necessary amount. As a result, the retraction of the braking operation member BP is suppressed, and the discomfort for the driver can be reduced.

### <Operation of Application Control>

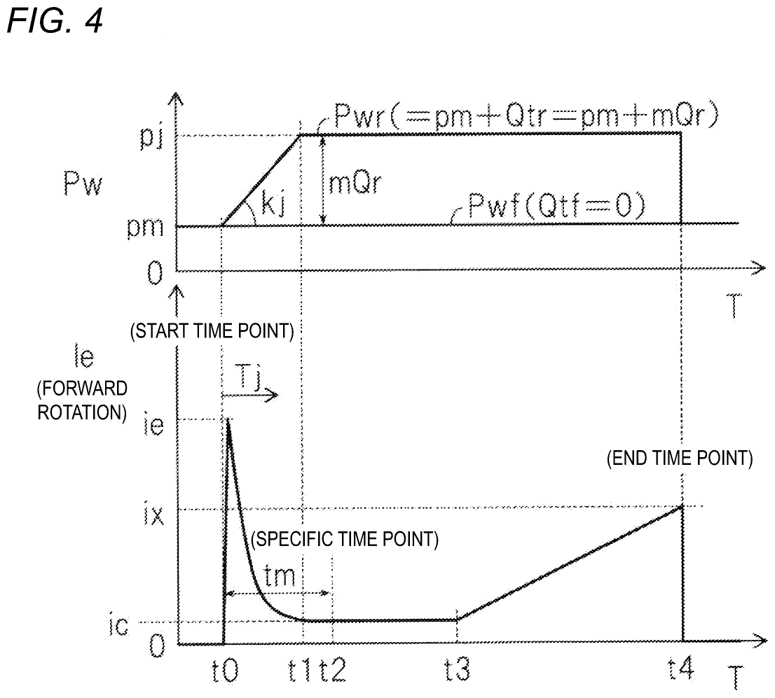

The operation of the application control will be described with reference to the time-series diagram (transition diagram of the state quantity with respect to the time T) of FIG. 4. In the example, the inrush current section in step S140 is determined based on the application duration time Tj calculated from the energization start time point to the second electric motor ME. Further, the driver operates the braking operation member BP before the application instruction, and the master cylinder fluid pressure Pm is maintained at a value pm.

At a time point to, the parking switch SW is switched from the off state to the on state, the instruction of the application actuation is issued, and the application control is started. At the time point to, the rear wheel target differential pressure Qtr starts to increase so that the rear wheel brake fluid pressure Pwr (=Pwp) increases. As a result, the rear wheel brake fluid pressure Pwr is increased from the value pm (=Pm) by the rear wheel differential pressure mor (actual value) corresponding to the rear wheel target differential pressure Qtr (target value) at the increase gradient kj (constant set in advance) (that is, “Pwr=pm+Qtr=pm+mQr”). On the other hand, since it is not necessary to pressurize the front wheel cylinder CWf (=CWn), the front wheel target differential pressure Qtf is calculated to “0”. As a result, the fluid pressure difference mof is not generated and remains “0”, and the front wheel brake fluid pressure Pwf (=Pwn) is equal to the value pm (=Pm).

At the time point to, a positive voltage is applied to the electric motor ME so that the second electric motor ME rotates forward. Accordingly, energization of the second electric motor ME corresponding to the forward rotation direction Da is started. From the time point to, the operation of the application duration time Tj is started. Here, the time point to corresponds to a “start time point”. In the example, the pressurization by the fluid unit HU and the driving of the second electric motor ME are started at the same time, but either one may be started first, and then the other may be started.

Immediately after the time point to (start time point), an inrush current (starting current) flows through the second electric motor ME. As a result, the motor energization amount Ie increases to a peak value ie and then decreases. However, since it is determined in step S140 that the time point to to a time point t2 are in the inrush current section, the determination in step S150 (magnitude comparison related to the energization amount Ie) is not performed.

When the rear wheel brake fluid pressure Pwr reaches the applied predetermined fluid pressure pj (predetermined threshold value set in advance) at a time point t1, the rear wheel target differential pressure Qtr is maintained constant. As a result, the rear wheel brake fluid pressure Pwr is maintained at a constant value pj.

At the time point t2 (referred to as “specific time point”) at which the specific application time tm, which is a predetermined time, has elapsed from the time point to, it is determined that the current is not in the inrush current section. By this determination, it is determined that the influence of the inrush current has been eliminated, and the determination in step S150 is performed.

From the time point to to a time point t3, the end surface Mp of the output member SB and the bottom surface Mb of the brake piston PN are not in contact with each other (see the state (a) of FIG. 2). Therefore, the motor energization amount Ie is substantially constant at a value ic. From the time point t3, the motor energization amount Ie starts to increase. This is because after the time point t3, the end surface Mp of the output member SB and the bottom surface Mb of the brake piston PN come into contact with each other, and the load of the second electric motor ME increases (see the state (b) of FIG. 2).

At the time point t3, the energization amount Ie of the second electric motor ME reaches the applied threshold amount ix which is the termination threshold value. At the time point t3, step S160 is satisfied, and the application control is terminated. The energization to the rear wheel pressure regulating valve UAr is stopped, and the driving of the first electric motor MA is terminated. The application of the positive voltage to the second electric motor ME is stopped, and the energization amount Ie is set to “0”.

### <Processing of Release Control>

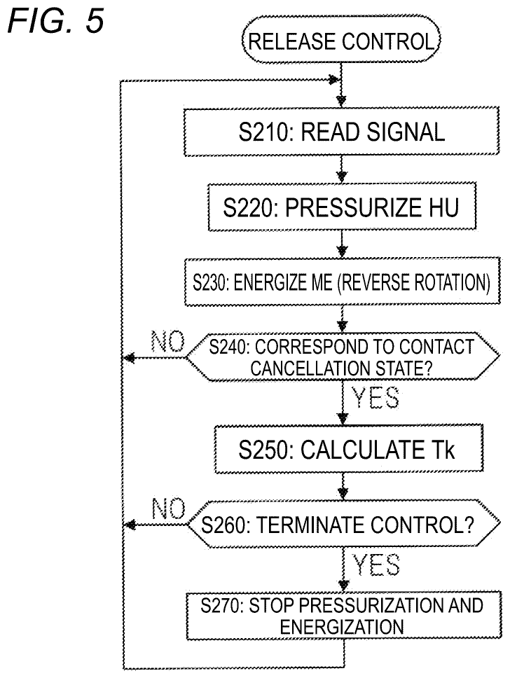

The processing of the release control will be described with reference to the flowchart of FIG. 5. The “release control” is control for transitioning from the application state in which the parking brake is effective to the release state in which the parking brake is not effective. That is, the release control is control for subjecting the parking brake to release actuation. The release control is started with the time point at which the parking signal Sw is switched from on to off. Here, switching the parking signal Sw from on to off is called “release instruction”. As in the application control, the electrically-powered unit DU is provided in the brake caliper CPr of the rear wheel WHr.

In step S210, various signals including the parking signal Sw, the master cylinder fluid pressure Pm, the pressure regulating valve energization amount (for example, the current value) Ia, and the motor energization amount (for example, the current value) Ie are read. For example, the energization amount Ia (actual value) of the pressure regulating valves UA and the energization amount Ie (actual value) of the second electric motor ME are detected by the energization amount sensors IA, IE provided in the drive circuit DD. Furthermore, the energization amount sensor IE may be incorporated in the electric motor ME.

In step S220, the auxiliary pressurization control is executed. In the auxiliary pressurization control, the rear wheel brake fluid pressure Pwr (that is, the parking brake fluid pressure Pwp) is increased and the braking force Fm is increased by the fluid unit HU. In the auxiliary pressurization control, a certain ratio of the braking force Fm generated by self-locking is borne by the rear wheel brake fluid pressure Pwr. This facilitates driving of the second electric motor ME in the reverse rotation direction db. The increase in the rear wheel brake fluid pressure Pwr is performed in the same manner as in step S120. Specifically, the rear wheel target differential pressure Qtr (target value) corresponding to the rear wheel differential pressure mor (difference between master cylinder fluid pressure Pm and rear wheel brake fluid pressure Pwr, actual value) is calculated with the time point at which the release instruction is issued as a starting point. Then, the rear wheel target differential pressure Qtr is increased with an increase gradient kk until the rear wheel brake fluid pressure Pwr reaches a predetermined release fluid pressure pk, and is maintained constant after reaching the predetermined release fluid pressure pk. On the other hand, a front wheel target differential pressure Qtf related to the front wheel braking system BKf (that is, the front wheel cylinder CWf) is calculated to “0”. Here, the predetermined release fluid pressure pk is a predetermined value (constant) set in advance.

In step S230, the electric motor ME is energized so that the second electric motor ME is driven in the reverse rotation direction db. Specifically, at the time point of the release instruction, a negative sign (−) voltage is applied to the second electric motor ME. After the start of the energization to the second electric motor ME, the application of the negative voltage to the electric motor ME is continued. As a result, the energization amount Ie (negative value) is energized to the second electric motor ME, and the electric motor ME is continuously driven in the reverse rotation direction db.

In step S240, “being in the contact cancellation state or not (referred to as “contact cancellation determination”)” is determined. The “contact cancellation state” is a state in which the end surface Mp of the output member SB in contact with the bottom surface Mb of the brake piston PN no longer comes into contact with each other. For example, the contact cancellation determination is performed as to “whether or not the energization amount Ie is in a constant state” based on the motor energization amount Ie. This is based on the fact that when the end surface Mp of the output member SB and the bottom surface Mb of the brake piston PN are separated, the output of the electric motor ME is used only for the friction (sliding friction) of a power transmission mechanism (electric motor ME, speed reducer GS, input member NB, output member SB, brake piston PN, and the like) from the electric motor ME to the friction member MS. In other words, the magnitude of the energization amount Ie supplied to the electric motor ME in the contact cancellation state is a value corresponding to friction of the power transmission member.

For example, the “constant state of energization amount Ie (that is, the contact cancellation state)” is determined with a time point at which a state in which the energization amount Ie falls within a predetermined range (within the range of a determination amount ih) set in advance is continued for a predetermined time th (referred to as “determination time”). In addition, the contact cancellation state may be determined with a time point at which a state in which a change amount dIe (time differential value of the energization amount Ie) with respect to the time T is equal to or less than a determination change amount dx in the energization amount Ie is maintained over a determination time th. Here, the determination amount ih, the determination time th, and the determination change amount dx are predetermined values (constants) set in advance.

When it is determined in step S230 to “be in the contact cancellation state (also referred to as “contact cancellation confirmed”)”, a control flag FF (also referred to as “determination flag”) is changed from “0” to “1”. Here, in the determination flag FF, “not being in the contact cancellation state, or the contact state being unknown” is displayed with “0” (also referred to as “contact cancellation unconfirmed”), and “contact cancellation confirmed” is displayed with “1”. Note that the determination flag FF is set to “0 (contact cancellation unconfirmed)” as an initial value before the start of execution of the release control.

In a case where the result of step S240 is negative, the process returns to step S210. On the other hand, in a case where the result of step S240 is affirmative, the process proceeds to step S250.

In step S250, a cancellation duration time Tk is calculated. The cancellation duration time Tk is a time from the time point (a corresponding calculation cycle, referred to as “confirmation time point”) when the affirmative determination is made for the first time in step S240. In other words, the cancellation duration time Tk is a time elapsed from the confirmation time point at which the contact cancellation unconfirmed state is switched (transitioned) to the contact cancellation confirmed state to the start point (reference).

In step S260, “whether or not the cancellation duration time Tk is equal to or longer than a cancellation threshold time tk” is determined. Here, the cancellation threshold time tk is a predetermined value (constant) set in advance and is a threshold value corresponding to the cancellation duration time Tk for terminating the release control (release actuation). In a case where “Tk<tk” is satisfied and the result of step S260 is negative, the process returns to step S210. On the other hand, in a case where “Tk≥tk” is satisfied and the result of step S260 is affirmative, the process proceeds to step S270.

In step S270, pressurization by the fluid unit HU and energization to the second electric motor ME are stopped. That is, at the time point when the predetermined time tk has elapsed from the time point when the contact cancellation is confirmed, the release control is terminated, and the parking brake is brought into the ineffective state.

Also in the release control of the parking brake device EP, similarly to the application control, in the fluid unit HU, the front wheel brake fluid pressure Pwf (=Pwn) is not increased (pressurized) in the front wheel cylinder CWf (=CWn), and the fluid pressure Pwr (=Pwp) is increased (pressurized) only by the rear wheel cylinder CWr (=CWp). The brake fluid BF is suctioned and discharged by the fluid pumps QA (=QAf, QAr), but the inlet valves VI, the outlet valves VO, and the front wheel pressure regulating valve UAf are in a non-energized state, and only the rear wheel pressure regulating valve UAr is energized. Since the front wheel brake fluid pressure Pwf is not increased, the volume of the front wheel cylinder CWf is not increased. That is, the suction amount (the amount of the brake fluid BF supplied from the master reservoir RV via the cup seal CS) corresponding to the front wheel cylinder CWf is “0”. Therefore, the suction amount is limited to an amount corresponding to an increase in the rear wheel brake fluid pressure Pwr. Since the suction amount of the brake fluid BF is limited, the retraction of the braking operation member BP is suppressed, and the discomfort for the driver can be reduced.

### <Operation of Release Control>

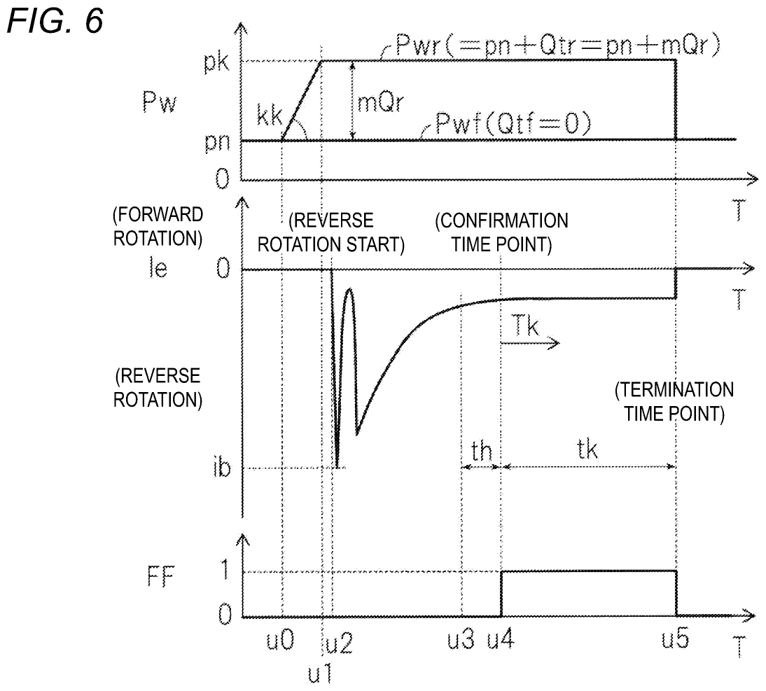

The operation of the release control will be described with reference to the time-series diagram of FIG. 6. In the rotation direction of the second electric motor ME, the positive sign (+) of the motor energization amount Ie (for example, the current value) corresponds to the forward rotation direction Da, and the negative sign (−) corresponds to the reverse rotation direction db. In the example, the driver operates the braking operation member BP before the release instruction, and the master cylinder fluid pressure Pm is maintained at a value pn.

At a time point u0, the parking switch SW is switched from the on state to the off state, an instruction of release actuation is issued, and release control is started. At the time point u0, the rear wheel target differential pressure Qtr starts to increase so that the rear wheel brake fluid pressure Pwr (=Pwp) is increased. As a result, the rear wheel brake fluid pressure Pwr is increased from the value pn (=Pm) by the rear wheel differential pressure mor (actual value) corresponding to the rear wheel target differential pressure Qtr (target value) at the increase gradient kk (constant set in advance) (that is, “Pwr=pn+Qtr=pn+mQr” is satisfied). Similarly to the application control, the front wheel target differential pressure Qtf is calculated to “0”, and the front wheel fluid pressure difference mQf is not generated. Therefore, the front wheel brake fluid pressure Pwf (=Pwn) is equal to the value pn (=Pm).

When the rear wheel brake fluid pressure Pwr reaches the predetermined release fluid pressure pk (predetermined threshold value set in advance) at a time point u1, the rear wheel target differential pressure Qtr is maintained constant. As a result, the rear wheel brake fluid pressure Pwr is maintained at the constant value pk.

At a time point u2, a negative voltage is applied to the electric motor ME such that the second electric motor ME reversely rotates. Accordingly, energization of the second electric motor ME corresponding to the reverse rotation direction db is started. In the example, the pressurization by the fluid unit HU and the driving of the second electric motor ME are started at different time points, but may be started simultaneously at the time point u0.

At a time point u3, the energization amount Ie of the second electric motor ME becomes substantially constant for the first time, and it is determined that “the energization amount Ie becomes constant”. However, at the time point u3, since the constant state of the energization amount Ie has not been continued for the determination time th, the contact cancellation state is not determined (confirmed).

At a time point u4 after a lapse of the determination time th (constant set in advance) from the time point u3, it is determined (confirmed) to be in the contact cancellation state, and step S240 is satisfied. Accordingly, at the time point u4 (confirmation time point), the determination flag FF is switched from “0 (contact cancellation unconfirmed)” to “1 (contact cancellation confirmed)”, and the calculation of the cancellation duration time Tk (integration of time) is started.

At a time point u5 after a lapse of the cancellation threshold time tk (constant set in advance) from the time point u4, step S260 is satisfied, and the release control is terminated. The energization to the rear wheel pressure regulating valve UAr is stopped, and the driving of the first electric motor MA is terminated. The application of the negative voltage to the second electric motor ME is stopped, and the energization amount Ie thereof is set to “0”. At this time, the determination flag FF is returned from “1” to the initial value “0”.

### <Second Embodiment of Parking Brake Device EP>

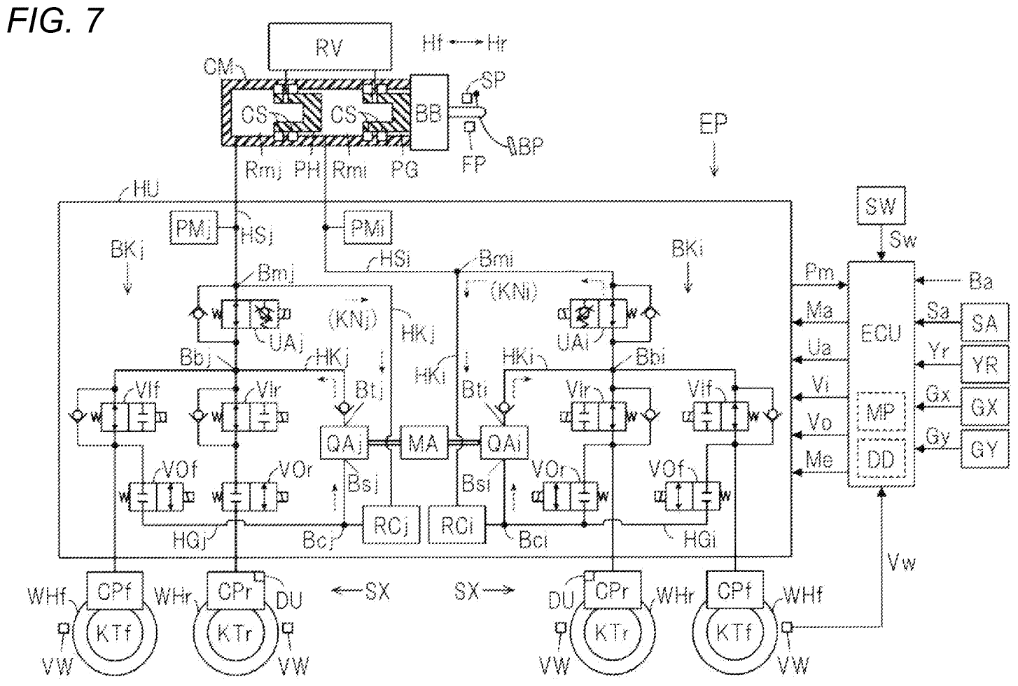

A second embodiment of the parking brake device EP will be described with reference to a schematic view of FIG. 7. In the first embodiment, the front-rear type is adopted in the braking system related to the master cylinder CM and the fluid unit HU, but in the second embodiment, a diagonal type (also referred to as “X type”) is adopted. That is, in the tandem type master cylinder CM, the first-side master chamber Rmi of the two fluid pressure chambers is connected to the right front wheel cylinder and the left rear wheel cylinder, and the second-side master chamber Rmj is connected to the left front wheel cylinder and the right rear wheel cylinder. Also in the second embodiment, similarly to the first embodiment, the parking brake acts on the rear wheels WHr. That is, the electrically-powered unit DU is provided on the rear wheel calipers CPr.

The second embodiment is different from the first embodiment in the method of increasing the rear wheel brake fluid pressure Pwr. In the first embodiment, after the inlet valves VI, the outlet valves VO, and the front wheel pressure regulating valve UAf are brought into the non-energized state, the first electric motor MA and the rear wheel pressure regulating valve UAr are energized, and the rear wheel brake fluid pressure Pwr is increased. Instead, in the second embodiment, the two pressure regulating valves UA (that is, the first-side and second-side pressure regulating valves UAi, UAj) and the front wheel inlet valves VIf corresponding to the front wheel cylinders CWf among the inlet valves VI are energized. Therefore, among the inlet valves VI, the rear wheel inlet valves VIr corresponding to the rear wheel cylinders CWr and all the outlet valves VO (=VOf, VOr) are in the non-energized state.

Hereinafter, an increase in the braking force Fm at the parking wheel WHp (that is, the rear wheels WHr) will be described in detail. The first electric motor MA is driven, and the brake fluid BF is suctioned and discharged by a first-side fluid pump and a second-side fluid pump QAi, QAj (=QA). As a result, in the first-side and second-side braking systems BKi, BKj (=BK), a first-side circulation flow and a second-side circulation flow KNi, KNj (=KN) including the pressure regulating valves UA, the fluid pumps QA, and the pressure regulating reservoirs RC are formed via the communication paths HS (=HSi, HSj) and the reflux paths HK (=HKi, HKj) as indicated by broken arrows. The first-side and second-side pressure regulating valves UAi, UAj (=UA) are energized to narrow the circulation flows KN, and a first-side regulated fluid pressure and a second-side regulated fluid pressure Pqi, Pqj (=Pq), which are the fluid pressures of lower portions Bbi, Bbj of the first-side and second-side pressure regulating valves UAi, UAj, are increased from a first-side master cylinder fluid pressure and a second-side master cylinder fluid pressure Pmi, Pmj (=Pm). That is, the master cylinder fluid pressure Pm is increased by a first-side differential pressure and a second-side differential pressure mQi, moj (=mQ), and the regulated fluid pressure Pq is generated. In the first-side and second-side braking systems BKi, BKj, since the front wheel inlet valves VIf are energized, the front wheel inlet valves VIf are closed. Therefore, the first-side and second-side regulated fluid pressures Pqi, Pqj (=Pq=Pm+mQ) are not supplied to the front wheel cylinders CWf (=CWn), but are supplied only to the rear wheel cylinders CWr (=CWp). That is, the front wheel brake fluid pressure Pwf (=Pwn) is not increased, only the rear wheel brake fluid pressure Pwr (=Pwp) is increased, and the braking force Fm with respect to the parking wheels WHp is increased.

In the second embodiment, the increase in the front wheel brake fluid pressure Pwf is avoided by closing the inlet valves VIf corresponding to the non-parking wheels WHn. When the operation amount Ba of the braking operation member BP is increased during the execution of the auxiliary pressurization control, the closed front wheel inlet valves VIf are opened. As a result, the driver's intention to brake is reflected on the front wheel brake fluid pressure Pwf. When the braking operation amount Ba is increased, it is difficult for the driver to feel the retraction of the braking operation member BP. Therefore, even if the retraction occurs due to the opening of the front wheel inlet valves VIf, the discomfort can be avoided.

Also in the second embodiment, the same effects as those of the first embodiment are obtained. In the actuation (at least one of application actuation and release actuation) of the parking brake device EP, the braking force Fm is increased not only by the electrically-powered unit DU but also by the fluid unit HU. Since the front wheel brake fluid pressure Pwf is not increased, the brake fluid BF suctioned from the master reservoir RV is not consumed in the front wheel cylinders CWf (that is, the non-parking wheel cylinders CWn). That is, the brake fluid BF from the master reservoir RV is consumed only in the rear wheel cylinders CWr (that is, the parking wheel cylinders CWp). As the suction amount of the brake fluid BF is larger, the degree of retraction is increased, but since the suction amount is limited in the auxiliary pressurization control, the retraction of the braking operation member BP is suppressed, and the discomfort for the driver is reduced.

### Other Embodiments

Hereinafter, other embodiments will be described. In other embodiments, the same effect as described above (suppression of the retraction phenomenon of the braking operation member BP) is achieved.

In the above embodiment, the auxiliary pressurization control (that is, increase in braking force Fm by fluid unit HU) is performed in both the application control and the release control. Alternatively, the auxiliary pressurization control may be configured to be executed in any one of the application control and the release control.

In the above embodiment, the non-parking wheels WHn (vehicle wheels on which the parking brake is not applied) are the front wheels WHf, and the parking wheels WHp (vehicle wheels on which the parking brake is applied) are the rear wheels WHr. Alternatively, the non-parking wheels WHn may be the rear wheels WHr, and the parking wheels WHp may be the front wheels WHf. In the auxiliary pressurization control according to the configuration, when the parking brake is actuated, the rear wheel brake fluid pressure Pwr (=Pwn) is not increased, and only the front wheel brake fluid pressure Pwf (=Pwp) is increased. Furthermore, in the parking brake device EP according to the diagonal type braking system BK, in a case where the braking operation amount Ba is increased in the middle of the auxiliary pressurization control, the energization to the closed rear wheel inlet valves VIr (corresponding to the non-parking wheels WHn) are stopped and opened in order to prioritize the driver's braking operation. By this valve opening, the rear wheel brake fluid pressure Pwr (=Pwn) is increased with the increase in the master cylinder fluid pressure Pm.

In the above embodiment, a caliper type is adopted as the parking brake. Alternatively, a drum brake type may be employed. In the drum brake type, the friction member MS is a brake lining, and the rotating member KT is a brake drum. In addition, the parking brake device EP adopting the drum brake type is also applied to a vehicle (a vehicle that is not a brake-by-wire type) in which the braking operation characteristic (Sp-Fp characteristic) is determined by the rigidity of the members (master cylinder CM, braking pipe, brake lever, brake shoe, friction member MS, and the like) from the braking operation member BP to the friction member MS.

### <Summary of Embodiments Related to Parking Brake Device EP>

Hereinafter, embodiments of the parking brake device EP will be summarized. The parking brake device EP is applied to a vehicle in which the relationship between the operation force Fp and the operation displacement Sp in the braking operation member BP is determined according to the rigidity (elasticity, relationship between force and deformation amount) of the members from the braking operation member BP to the friction member MS. The parking brake device EP includes the electrically-powered unit DU, the fluid unit HU, and the controller ECU.

The fluid unit HU includes the fluid pumps QA and the pressure regulating valves UA. The fluid pumps QA suction the brake fluid BF from the master cylinder CM using the first electric motor MA (for reflux) as a motive power source. The pressure regulating valves UA increase the pressure of the brake fluid BF discharged from the fluid pumps QA and supply the brake fluid BF to the wheel cylinders CW as the brake fluid pressure Pw. Then, the fluid unit HU causes the brake fluid pressure Pw to presses the friction member MS against the rotating member KT fixed to the vehicle wheels WH of the vehicle to generate the braking force Fm. The fluid unit HU can generate the braking force Fm for all the vehicle wheels WH of the vehicle.

The electrically-powered unit DU uses a second electric motor ME (for parking brake) different from the first electric motor MA as a motive power source to generate the braking force Fm for the parking wheel WHp, among the vehicle wheels WH, on which the parking brake is applied. That is, the electrically-powered unit DU does not generate the braking force Fm for all the vehicle wheels WH of the vehicle, but generates the braking force Em only for the parking wheels WHp. The controller ECU controls the fluid unit HU and the electrically-powered unit DU.

In the parking brake device EP, in a case where the parking brake is actuated (in a case of performing at least one of application actuation and release actuation), the controller ECU increases only the brake fluid pressure (parking brake fluid pressure) Pwp of the parking wheel cylinders CWp corresponding to the parking wheels WHp among the wheel cylinders CW. That is, in a case where the parking brake is actuated, the controller ECU does not increase the brake fluid pressure (non-parking brake fluid pressure) Pwn of the non-parking wheel cylinders CWn corresponding to the non-parking wheels WHn (vehicle wheels on which the parking brake is not applied) among the wheel cylinders CW.

When the brake fluid pressure Pw is increased by the fluid unit HU, the brake piston PN is moved in the advancing direction Ha (direction approaching the rotating member KT). Since the amount of the brake fluid BF existing in the braking system BK becomes insufficient by this movement, this shortage is compensated from the master reservoir RV. When the braking operation member BP is operated, the inflow of the brake fluid BF from the master reservoir RV into the master cylinder CM is through the cup seal CS. However, due to this inflow, a retraction phenomenon of the braking operation member BP (a phenomenon in which the braking operation member BP is slightly moved in the advancing direction Hf) may occur. The magnitude of the movement of the braking operation member BP increases as the inflow amount (that is, the suction amount) increases. Therefore, in the parking brake device EP, in a case where the auxiliary pressurization control (control for increasing the braking force Fm by the fluid unit HU in addition to the electrically-powered unit DU) is executed, the inflow of the brake fluid BF is limited to the minimum necessary amount so as not to increase the non-parking brake fluid pressure Pwn corresponding to the non-parking wheels WHn on which the parking brake is not applied. As a result, the degree of retraction is reduced, and the discomfort for the driver is suppressed.

The parking brake device EP is applied to a vehicle including front-rear type braking systems BKf, BKr. For example, in the vehicle, the rear wheels WHY are the parking wheels WHp, and the front wheels WHY are the non-parking wheels WHn. In this configuration, the fluid unit HU includes the normally-opened front wheel and rear wheel pressure regulating valves UAf, UAr in the front-rear type braking systems BKf, BKr as the pressure regulating valves UA. Furthermore, in a case of actuating the parking brake, the controller ECU does not energize the front wheel pressure regulating valve UAf but energizes only the rear wheel pressure regulating valve UAr. As a result, in the auxiliary pressurization control, the front wheel brake fluid pressure Pwf (that is, the non-parking brake fluid pressure Pwn) is not increased, and only the rear wheel brake fluid pressure Pwr (that is, the parking brake fluid pressure Pwp) is increased.

The parking brake device EP is applied to a vehicle including diagonal type braking systems BKi, BKj. For example, also in the vehicle, similarly to the above, the rear wheels WHr are the parking wheels WHp, and the front wheels WHf are the non-parking wheels WHn. In this configuration, the fluid unit HU includes, as the pressure regulating valves UA, the normally-opened first-side and second-side pressure regulating valves UAi, UAj in the diagonal type braking systems BKi, BKj. In addition, normally-opened front wheel and rear wheel inlet valves VIf, VIr are provided between the first-side and second-side pressure regulating valves UAi, UAj and the wheel cylinders CW. In a case where the parking brake is actuated, the controller ECU energizes the front wheel inlet valves VIf to close the front wheel inlet valves VIf, and does not energize the rear wheel inlet valves VIr but keeps the rear wheel inlet valves VIr open. In this state, the first-side and second-side pressure regulating valves UAi, UAj are energized. As a result, in the auxiliary pressurization control, the front wheel brake fluid pressure Pwf (that is, the non-parking brake fluid pressure Pwn) is not increased, and only the rear wheel brake fluid pressure Pwr (that is, the parking brake fluid pressure Pwp) is increased.

1. A parking brake device for a vehicle, the parking brake device comprising:
a fluid unit including a fluid pump that suctions a brake fluid from a master cylinder using a first electric motor as a motive power source, and a pressure regulating valve that increases a pressure of the brake fluid discharged by the fluid pump and supplies the increased pressure to a wheel cylinder as a brake fluid pressure, the fluid unit causing the brake fluid pressure to press a friction member against a rotating member fixed to vehicle wheels of the vehicle to generate a braking force;
an electrically-powered unit that uses a second electric motor as a motive power source and generates the braking force on a parking wheel on which a parking brake is applied among the vehicle wheels; and
a controller that controls the fluid unit and the electrically-powered unit, wherein,
the controller increases,
in a case where the parking brake is actuated, only the brake fluid pressure corresponding to the parking wheel in the wheel cylinder.

2. The parking brake device for a vehicle according to claim 1,
wherein the parking wheel is a rear wheel of the vehicle, and the non-parking wheel is a front wheel of the vehicle,
the fluid unit includes, as the pressure regulating valve, a front wheel pressure regulating valve and a rear wheel pressure regulating valve that are normally opened in a front-rear type braking system, and
the controller is configured
not to energize the front wheel pressure regulating valve and to energize only the rear wheel pressure regulating valve in a case where the parking brake is actuated.

3. The parking brake device for a vehicle according to claim 1,
wherein the parking wheel is a rear wheel of the vehicle, and the non-parking wheel is a front wheel of the vehicle,
the fluid unit includes, as the pressure regulating valve, a first-side pressure regulating valve and a second-side pressure regulating valve that are normally opened in a diagonal type braking system, and a front wheel inlet valve and a rear wheel inlet valve that are normally opened between the first-side pressure regulating valve and the second-side pressure regulating valve and the wheel cylinder, and
the controller is configured to
energize the front wheel inlet valve to close the front wheel inlet valve, keep the rear wheel inlet valve open without energizing the rear wheel inlet valve, and energize the first-side pressure regulating valve and the second-side pressure regulating valve in a case where the parking brake is actuated.
